(19) United States
(12) Patent Application Publication
(10) Pub. No.: US 2025/0070623 A1
(43) Pub. Date: Feb. 27, 2025

(54) MOTOR FOR ELECTRIC POWER TOOLS

(71) Applicant: MAKITA CORPORATION, Anjo-shi (JP)

(72) Inventor: Yoshimasa FUKUOKA, Anjo-shi (JP)

(73) Assignee: MAKITA CORPORATION, Anjo-shi (JP)

(21) Appl. No.: 18/815,134

(22) Filed: Aug. 26, 2024

(30) Foreign Application Priority Data
Aug. 25, 2023 (JP) 2023-137077

(51) Int. Cl. H02K 11/00; H02K 1/18; H02K 11/21

(52) U.S. Cl. CPC H02K 11/0094; H02K 1/18; H02K 11/21; H02K 2213/03

(57) ABSTRACT

A motor used for an electric power tool includes a cylindrical-shaped stator, a rotor arranged on an inner circumferential side of the stator, and a sensor board arranged at an axial end of the stator. The sensor board includes a board main body located radially inside of the stator when viewed from an axial direction of the stator, and a leg protruding radially outward from the board main body toward the stator. The stator is exposed at least on one side of the leg in a circumferential direction of the stator. The motor further includes a sensor which is mountable on the leg so as to face the rotor and detects rotation of the rotor.

### CROSS-REFERENCE TO RELATED APPLICATION

This application claims priority to Japanese patent application serial number 2023-137077, filed on Aug. 25, 2023, the contents of which are incorporated herein by reference in their entirety for all purposes.

### TECHNICAL FIELD

The present invention generally relates to a motor used for an electric power tool, such as, for example, a chain saw.

### BACKGROUND

Electric power tools such as, for example, a chain saw, has a motor serving as a driving source. A so-called DC blushless motor is used for a motor. A DC blushless motor has a cylindrical-shaped stator and a rotor located radially inside of the stator and rotating integral with a motor shaft. Also, the DC blushless motor has more than one teeth protruding from an inner peripheral edge of the stator toward a radially inside of the stator. A coil is wound around each of the teeth. The DC blushless motor has a sensor board on which a hall element is mounted as a sensor. The sensor board has approximately a circular plate shape extending in a direction perpendicular to an axis of the motor shaft at a circular shaped opening of the stator. The sensor board is disposed adjacent to the rotor in the axis direction of the motor shaft. The hall element detects a rotation of the rotor.

A fan is attached to the motor shaft for generating a cooling air flow. The cooling air flow generated by a rotation of the fan flows within the stator across the sensor board to cool, for example, a coil wound around the teeth. Further, the cooling air flow also cools a controller for controlling a drive of the motor by utilizing a negative pressure produced by the cooling air flow flowing within the stator.

A sensor board used in a conventional electric power tool has a circular plate shape covering most of the opening of a cylindrical-shaped stator. In recent years, a motor with a larger output has been used in accordance with an increase of power of the machines. Therefore, when a sensor board used in a conventional machine is attached to the stator, an air resistance of the motor will be large. Owing to this, the motor will not be sufficiently cooled by the cooling air, which may cause a temperature of the motor to rise. Also, there is a possibility that a cooling air flow will not be sufficiently generated because of a reduced negative pressure of the cooling air flow for cooling the motor, which may cause the temperature of the controller to rise. Accordingly, there is a possibility that the motor and the controller are damaged.

Therefore, there is a need for an electric power tool to generate an adequate cooling air flow flowing within the motor.

### SUMMARY OF THE DISCLOSURES

According to one aspect of the present disclosure, a motor used for an electric power tool includes a cylindrical-shaped stator. The motor further includes a rotor arranged on an inner circumferential side of the stator. The motor further includes a sensor board arranged at an axial end of the stator. The sensor board includes a board main body arranged radially inward of the stator when viewed from an axial direction of the stator. The sensor board includes a leg which protrudes radially outward from the board main body toward the stator. The stator is exposed on at least one side of the leg in the circumferential direction of the stator. The motor further includes a sensor which is mounted on the leg so as to face the rotor and detects rotation of the rotor 28.

Because of this configuration, a cooling air flowing inside the stator from a portion in which the stator is exposed on at least one side of the leg in the circumferential direction of the stator. Accordingly, an air resistance of the motor can be reduced. The sensor is mounted on the leg that protrudes radially outward from the board main body of the sensor board. Thus, the stator is exposed in at least one side of the leg in the circumferential direction of the stator. This configuration exposes the stator in a broad area along an inner circumferential edge of the stator, where the sensor is positioned such that the rotation of the rotor can be detected. Accordingly, a cooling air flows along the inner circumferential edge of the stator, thereby increasing a quantity of cooling air flowing through the inside of the motor. Thus, even in a case where an output power of the motor is increased, the motor and the like can be restricted from being damaged.

### BRIEF DESCRIPTION OF DRAWINGS

FIG. 1 is a perspective view of an electric power tool according to a first embodiment of the present disclosure.

FIG. 2 is a view taken along line II-II of FIG. 1.

FIG. 3 is a perspective view of a motor according to the first embodiment.

FIG. 4 is a left side view of the motor viewed from a first direction from which a sensor board is attached to the motor.

FIG. 5 is a right side view of a stator to which the sensor board is attached, viewed from a second direction opposite to the first direction.

FIG. 6 is a perspective view of a sensor unit viewed from a side of the first direction.

FIG. 7 is a perspective view of the sensor unit from which a mold is removed, viewed from a side of the first direction.

FIG. 8 is a perspective view of the sensor unit from which the mold is removed, viewed from a side of the second direction.

FIG. 9 is a left side view of a stator to which a sensor board of a second embodiment of the present disclosure is attached, viewed from the first direction.

FIG. 10 is a right side view of the stator to which the sensor board is attached, viewed from the second direction.

FIG. 11 is a view taken along line XI-XI of FIG. 9.

FIG. 12 is a perspective view of the sensor unit viewed from a side of the first direction.

FIG. 13 is a perspective view of the sensor unit viewed from a side of the second direction.

FIG. 14 is a left side view of a stator to which a conventional sensor board is attached, viewed from the first direction.

### DETAILED DESCRIPTION

The detailed description set forth below, when considered with the appended drawings, is intended to be a description of exemplary embodiments of the present disclosure and is not intended to be restrictive and/or representative of the only embodiments in which the present disclosure can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the disclosure. It will be apparent to those skilled in the art that the exemplary embodiments of the disclosure may be practiced without these specific details. In some instances, these specific details refer to well-known structures, components, and/or devices that are shown in block diagram form in order to avoid obscuring significant aspects of the exemplary embodiments presented herein.

According to one aspect of the present disclosure, the stator includes a cylindrical-shaped outer cylinder portion. The stator also includes teeth, each of which protrudes radially inward from the outer cylinder portion and a coil is wound around. An inner circumferential end of each teeth is exposed when viewed from an axial direction of the stator. Because of this configuration, an exposed area of each teeth viewed from the axial direction of the stator can be increased. Accordingly, the coil would around each teeth can be efficiently cooled by a large quantity of cooling air.

According to another aspect of the present disclosure, the sensor board includes a mounting leg which protrudes radially outward from the board main body and is attached to the stator. A cooling air is allowed to flow in an area adjacent to the mounting leg in a circumferential direction of the stator by arranging the mounting leg protruding radially outward from the board main body. Accordingly, a flowing quantity of cooling air can be increased while stability of a supporting configuration for supporting the sensor board is improved.

According to another aspect of the present disclosure, the stator includes a cylindrical-shaped outer cylinder portion. The stator includes a plurality of teeth, each of which protrudes radially inward from the outer cylinder portion and a coil is wound around each teeth. The leg and the mounting leg are positioned so as to avoid a center of the inner circumferential end of each of the plurality of teeth when viewed from the axial direction of the stator. In other words, the leg and the mounting leg are arranged in areas though which a cooling air flowing toward each teeth in the axial direction of the stator does not pass. Accordingly, a coil wound around each teeth can be efficiently cooled by the cooling air, thereby enhancing a cooling efficiency of the motor.

According to another aspect of the present disclosure, the sensor board includes at least one leg and at least one mounting leg. The leg and the mounting leg are positioned differently from the center of the inner circumferential end of each teeth when viewed from in the axial direction of the stator, and thus the center of the inner circumferential end of each of the plurality of teeth is exposed. Accordingly, the center of the inner circumferential end of each teeth is exposed when viewed from in the axial direction of the stator. This configuration enhances a cooling efficiency of the motor, while the sensor on the leg can be arranged in a position so as to sufficiently detect rotation of the rotor and also stability of a supporting configuration for supporting the sensor board by the mounting leg can be improved.

According to another aspect of the present disclosure, the motor includes a cylindrical-shaped stator having an outer cylinder portion. The motor further includes a plurality of teeth each of which protrudes radially inward from the outer cylinder portion and a coil is would around. The motor further includes a rotor arranged on an inner circumferential side of the plurality of teeth. The motor includes a sensor board arranged at an axial end of the stator. The sensor board includes an annular board main body along a radially inward of the inner circumferential end of the plurality of teeth when viewed from an axial direction of the stator. A center of at least one inner circumferential end of the plurality of teeth is exposed in a direction radially outward of the board main body. The motor includes a sensor which is mounted on the sensor board so as to face the rotor and detects rotation of the rotor.

Because of this configuration, a space is provided between the board main body and the inner circumferential end of each of the plurality of teeth in a radial direction of the stator. An exposed area of the teeth 24 can be increased owing to the space. Accordingly, an air resistance of the motor can be reduced. Also, a center of at least one inner circumferential end of the plurality of teeth is exposed when viewed from an axial direction of the stator. Accordingly, a cooling air flows adjacent to the center of the inner circumferential end of each teeth. Because of this configuration, a coil wound around each teeth can be efficiently cooled. Accordingly, ever in a case where an output power of the motor is increased, the motor and the like can be restricted from being damaged.

According to another aspect of the present disclosure, the sensor board includes a leg protruding radially outward from the board main body. A sensor is mounted on the leg. Accordingly, a space is provided adjacent to the leg in a circumferential direction of the sensor board, while the sensor is arranged on the leg so as to sufficiently detect rotation of the rotor. Because of this configuration, a flowing quantity of the cooling air flowing into an inside of the motor can be increased.

According to another aspect of the present disclosure, the sensor board includes at least one mounting leg which protrudes radially outward from the board main body and is attached to the stator. The sensor board also includes at least one leg which protrudes radially outward from the board main body and on which the sensor is mounted. Each of the leg and each of the mounting leg are arranged so as to avoid the center of the inner circumferential end of each teeth when viewed in the axial direction of the stator. Because of this configuration, the center of the inner circumferential end of each of the plurality of teeth 24 is exposed. Accordingly, the coil each of which is would around each teeth can be efficiently cooled, thereby further improving a cooling efficiency of the motor.

According to another aspect of the present disclosure, the motor includes three sensors. The sensor board includes three legs on each of which one of the sensor is mounted. Thus, rotation of the rotor can be sufficiently detected by use of the three sensors. Also, by arranging each of three sensors on a corresponding leg, a space adjacent to each leg in the circumferential direction of the stator can be enlarged. Accordingly, a quantity of the cooling air flowing into the inside of the motor can be increased.

According to another aspect of the present disclosure, the motor used for the electric power tool includes the cylindrical-shaped stator. The motor includes the rotor arranged on the inner circumferential side of the stator. The motor includes the sensor board at the axial end of the stator. The sensor board includes the board main body located radially inward of the inner circumferential edge of the stator when viewed from the axial direction of the stator. The sensor board includes an outer side surface of the board main body disposed on a side opposite to the rotor. The sensor board includes a tilting surface on the outer side surface of the board main body so as to be tilted toward the inner side in the axial direction of the stator, where the rotor is located, as it extends radially outward. When viewed from the axial direction, a space is formed between the outer circumferential edge of the board main body and the inner circumferential edge of the stator. The motor includes a sensor that is mounted on the sensor board so as to face the rotor and detects rotation of the rotor.

As described above, the tilting surface is formed on the outer side surface of the board main body so as to be tilted toward the inner side in the axial direction of the motor. Because of this configuration, a cooling air flowing toward the board main body can be guided by the tilting surface. Accordingly, an air resistance of the motor can be reduced. The tilting surface is tilted toward the inner side in the axial direction of the motor, where the rotor is located, as it extends in a radially outward direction. Accordingly, a cooling air can be guided toward the inner circumferential edge of the stator which is located radially outward of the tilting surface 46. Because of this configuration, a flowing quantity of the cooling air can be increased, thereby improving a cooling efficiency of the motor. Accordingly, even in a case where an output power of the motor is increased, the motor and the like can be restricted from being damaged.

According to another aspect of the present disclosure, the motor includes a mold covering a surface of the board main body. The tilting surface is formed according to the configuration of the outer side surface of the board main body or the configuration of the mold. Accordingly, with regard to the board main body that is covered by the mold, the tilting surface for guiding the cooling air can be formed, thereby reducing the air resistance of the motor.

According to another aspect of the present disclosure, the sensor board includes the mounting leg which protrudes radially outward from the board main body and is attached to the stator. The mounting leg does not include the tilting surface. Accordingly, strength of the mounting leg can be maintained, while the tilting surface is formed on a required position for guiding the cooling air so as to increase a cooling efficiency of the motor.

According to another aspect of the present disclosure, the sensor board includes the leg protruding radially outward from the board main body. The sensor is mounted on the leg. The sensor for detecting rotation of the rotor is mounted on the leg, which does not avoid the cooling air to be guided to the inside of the motor along the tilting surface of the board main body. Because of this configuration, air resistance can be reduced, thereby improving a cooling efficiency of the motor.

According to another aspect of the present disclosure, the tilting surface is tilted over the entire surface from the inner circumferential edge to the outer circumferential edge of the board main body in the radial direction of the board main body. Accordingly, the cooling air flowing toward the board main body in the axial direction of the stator can be smoothly guided outward in the radial direction of the board main body. Because of this configuration, an air resistance can be reduced, thereby improving a cooling efficiency of the motor.

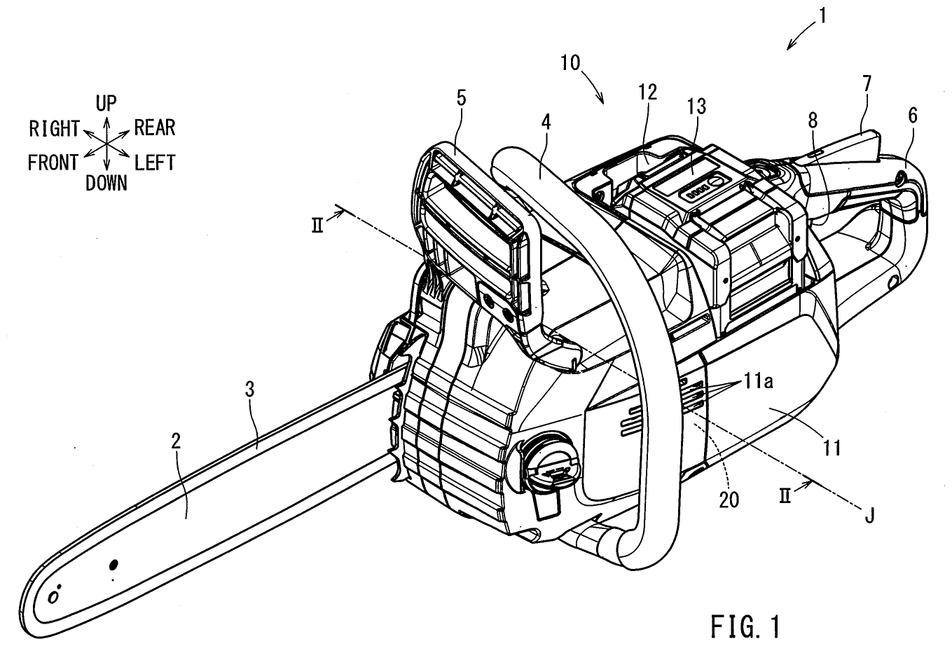

A first embodiment according to the present disclosure will be explained with reference to FIGS. 1 to 8. FIG. 1 shows an example of an electric power tool 1, e.g. a chain saw that drives a saw chain 3 by an output of an electric motor. In the following explanation, a direction in which a guide bar 2 for supporting the saw chain 3 protrudes is a forward direction. A user of the electric power tool 1 is generally situated on a rear side of the electric power tool 1 to hold the electric power tool 1. An upper side, a lower side, a left side and a right side are based on a user's position. Also, a leftward and rightward direction is also referred to as a first and second direction, respectively.

As shown in FIG. 1, an electric power tool 1 has a power tool main body 10 that is housed in a main body housing 11. A guide bar 2 protrudes from a front end of the main body housing 11 in a forward direction. A saw chain 3 is attached to the guide bar 2 along an outer periphery of the guide bar 2. The saw chain 3 is guided so as to move in a peripheral direction along the outer periphery of the guide bar 2. The saw chain 3 is driven by an output of a motor 20 that is mounted in the power tool main body 10.

As shown in FIG. 1, the electric power tool 1 has a front grip 4. The front grip 4 is formed in a loop shape on a front side of the main body housing 11. The front grip 4 extends upward from a lower end of a left side surface of the main body housing 11 and then extends rightward on an upper side of the main body housing 11. The front grip 4 is then connected to an upper end of a right side surface of the main body housing 11. The electric power tool 1 has a hand guard 5. The hand guard 5 is formed in front of an upper portion of the front grip 4. The hand guard 5 extends upward from an upper end of a front portion of the main body housing 11. The hand guard 5 protects a user's hand holding the front grip 4.

As shown in FIG. 1, the electric power tool 1 has a rear grip 6 on a rear side of the power tool main body 10. The rear grip 6 is formed in a loop shape extending from a rear end of the main body housing 11 in a rearward direction. A trigger lock lever 7 is provided on an upper side of the rear grip 6. The trigger lock lever 7 can be push-operated by a finger of the user's hand holding the rear grip 6. A trigger 8 is provided on an inner periphery side of the loop-shaped rear grip 6. The trigger 8 can be pull-operated by a finger of the user's hand holding the rear grip 6. The user pushes the trigger lock lever 7 while holding the rear grip 6. In this state, the user is allowed to pull the trigger 8 by a finger. By pulling the trigger 8, a driving current for driving the motor 20 is supplied to the motor 20. In contrast, when the trigger lock lever 7 is not push-operated, a pulling operation of the trigger 8 is prohibited.

As shown in FIG. 1, the power tool main body 10 has a battery attachment portion 12 to which a rechargeable battery 13 can be detachably attached. The battery attachment portion 12 is formed in a recessed manner on an upper surface of the power tool main body 10. The battery 13 can be attached to the battery attachment portion 12 by sliding the battery 13 downward from above. In contrast, the battery 13 can be detached from the battery attachment portion by sliding the battery upward from below. A driving current for driving the motor 20 is supplied to the motor 20 from the battery 13 attached to the battery attachment portion 12. The motor 20 is discussed later in detail. The battery 13 is, for example, a lithium-ion battery which output voltage is 40V. The battery 13 is removable from the battery attachment portion 12 for recharge by a dedicated charger. The battery 13 can be used as a power source for various electric power tools such as, for example, a nail driver, an electric drill, etc.

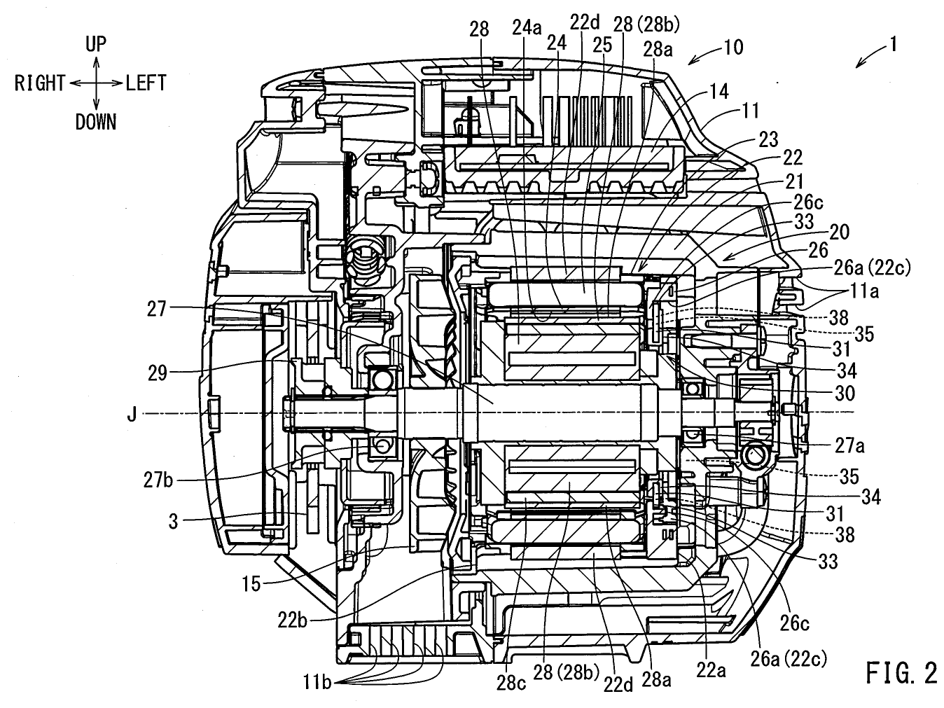

As shown in FIGS. 1 and 2, the main body housing 11 houses the motor 20 used for an electric power tool 1. The motor 20 is located on a lower side of the front grip 4 and in front of the battery attachment portion 12. The motor 20 is housed in an approximately tubular-shaped motor case 21 such that a motor shaft 27 of the motor 20 extends in a left-right direction. An axial direction of the motor shaft 27 is parallel to the left-right direction. Bearings 27a and 27b are attached to an inside of the motor case 21. The motor shaft 27 is supported by the bearings 27a and 27b so as to rotate around a motor axis J extending in the left-right direction. A right end of the motor shaft 27 protrudes from the motor case 21. A sprocket 29 for transmitting a rotation output of the motor 20 to the saw chain 3 is attached to the right end of the motor shaft 27. By rotating the motor shaft 27 around the motor axis J, the saw chain 3 is driven via the sprocket 29.

As shown in FIG. 2, the main body housing 11 houses a controller 14. The controller 14 has a shallow box-shaped rectangular case in which a circuit board is housed. The controller 14 is located above the motor case 21 and extends in an approximately left-right direction with its thickness direction in the up-down direction. The controller 14 outputs control signals for controlling the electric power tool 1. For example, when the controller 14 detects that the trigger 8 (refer to FIG. 1) is pulled, the controller 14 drives the motor 20 by supplying a driving current from the battery 13 to the motor 20. Also, the controller 14 receives a signal showing a rotation of the rotor 28 from a sensor 35. The rotation of the rotor 28 includes a rotation position of the rotor 28 or a rotation speed of the rotor 28. Alternatively, the rotation of the rotor 28 includes both of them. The sensor 35 will be discussed later in detail. The controller 14 controls a driving current supplied to the motor 20 in accordance with the rotation of the rotor 28.

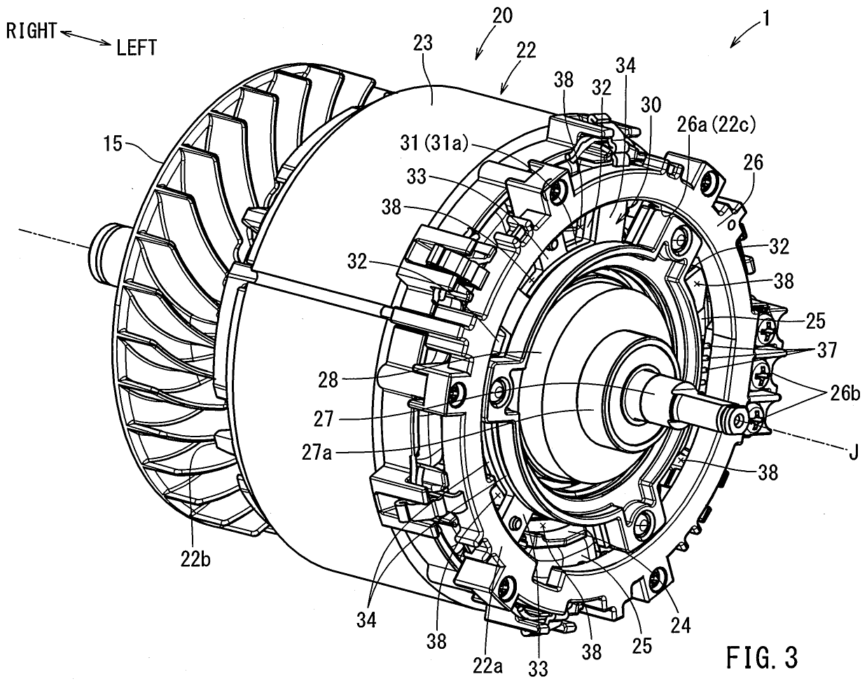

As shown in FIGS. 2 and 3, the motor 20 is an inner rotor type DC brushless motor. The motor 20 has a cylindrical-shaped stator 22. The stator 22 is housed in the motor case 21. A rotor 28 is arranged on an inner circumferential side of the stator 22. The rotor 28 is integrally attached to the motor shaft 27. The rotor 28 is rotatable around the motor axis J with respect to the stator 22. A cooling fan 15 is integrally attached to the motor shaft 27. The cooling fan 15 is a centrifugal fan. The cooling fan 15 is arranged on a right side of the right end of the stator 22 and on a left side of the right bearing 27b. The cooling fan 15 rotates integrally with the motor shaft 27 such that a cooling air flows inside the motor case 21 from left to right in an axial direction of the motor 20. The cooling air that reaches the cooling fan 15 flows radially outside by the cooling fan 15.

As shown in FIG. 2, an inlet port 11a is arranged on a left surface of the main body housing 11. Also, the inlet port 11a is disposed to the left of the motor 20. The inlet port 11a passes through the main body housing 11 in the left-right direction. When the cooling fan 15 rotates, an outside air is introduced from the inlet port 11a into the main body housing 11. An exhaust port 11b is arranged on a bottom surface of the main body housing 11. Also, the exhaust port 11b is disposed radially outside of the cooling fan 15. The cooling air that flows radially outside of the cooling fan 15 is discharged out of the main body housing 11 through the exhaust port 11b.

As shown in FIG. 2, the rotor 28 has a rotor core 28b that includes a plurality of laminated steel plates. The rotor core 28b is arranged on an inner circumferential side of the stator 22 so as to surround the motor shaft 27. The rotor 28 has a plurality of magnets 28c. The magnets 28c are permanent magnets. The magnets 28c are arranged inside of the rotor core 28b. The magnets 28c are circumferentially arranged around the motor shaft 27. In the present embodiment, eight magnets are arranged around the motor shaft 27.

As shown in FIGS. 2 and 3, the stator 22 has a first end 22a at a left end of the stator 22 (in a first direction). Also, the stator 22 has a second end 22b at a right end of the stator 22 on the opposite direction of the first end 22a (in a second direction). An outer circumferential edge of the stator 22 is covered by an approximately cylindrical-shaped outer cylinder portion 23. The stator 22 has a stator core 22d including a plurality of laminated steel plates. The stator core 22d is arranged along an inner circumferential edge of the outer cylinder portion 23.

As shown in FIGS. 2 to 4, the stator 22 has a plurality of teeth 24 protruding radially inward from the outer cylinder portion 23. The plurality of teeth 24 are circumferentially arranged at equal intervals. In the present embodiment, twelve teeth 24 are arranged. The twelve teeth 24 are circumferentially arranged at equal intervals of 30 degrees around the motor axis J. An inner circumferential end 24a of each teeth 24 is positioned slightly radially outward of an outer circumferential end 28a of the rotor 28. A coil 26 is wound around each teeth 24. A driving current is supplied from the battery 13 according to a control signal from the controller 14.

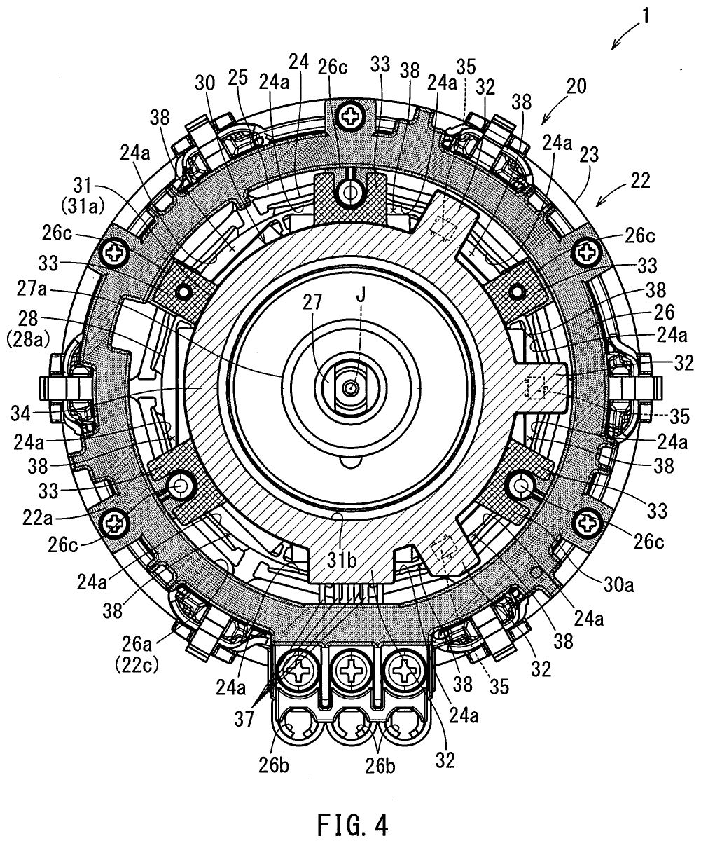

As shown in FIGS. 3 and 4, an approximately annular insulator 26 is integrally attached to an end of the stator 22 in the first direction. The insulator 26 is formed by an insulation material made of, for example, a synthetic resin. The insulator 26 is fixed to the stator core 22d by an insert molding. An end surface of the insulator 26 in the first direction is the first end 22a of the stator 22 in the present embodiment. An inner circumferential edge 26a of the insulator 26 is positioned radially inward of an inner circumferential edge of the outer cylinder portion 23. The inner circumferential edge 26a of the insulator 26 is an inner circumferential edge 22c of the stator 22 in the present embodiment.

As shown in FIGS. 3 and 4, the insulator 26 has connection portions 26b protruding radially outward of the insulator 26. For example, the coil 25 is connected to the battery 13, the sensor 35 is connected to the controller 14, and the battery 13 is connected to the controller 14 via the connection portions 26. The insulator 26 has a board connection portion 26c to which a sensor board 30 is attachable. The sensor board 30 is discussed later in detail. The board connection portion 26c protrudes radially inward from the inner circumferential edge 26a of the insulator 26. In the present embodiment, five board connection portions 26c are provided. The board connection portions 26c are circumferentially arranged at equal intervals of an approximately 60 degrees around the motor axis J. The board connection portion 26c is not provided on an inner circumferential side of an area in which the connection portions 26b are located.

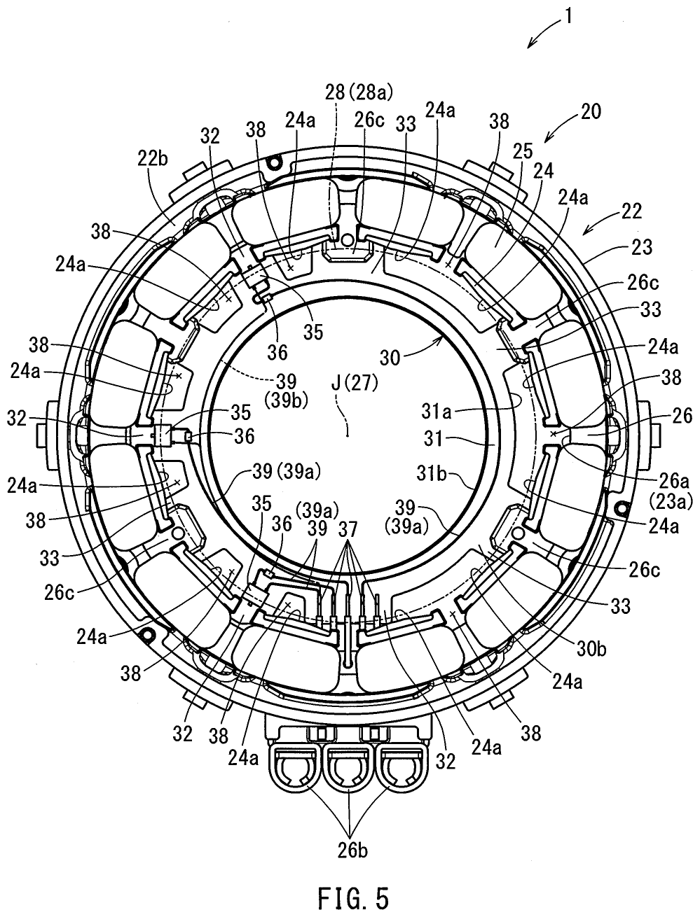

As shown in FIGS. 4 and 5, the motor 20 has a plurality of sensors 35. Each of the sensors 35 is a magnetic sensor that detects magnetism of the magnets 28c of the rotor 28 (refer to FIG. 2). Each of the sensors 35 is, for example, a hall element. Rotation of the rotor 28 can be detected by the sensors 35 that detect magnetism of the magnets 28c. The plurality of sensors 35 are mounted on a plate-shaped sensor board 30. Three sensors 35 are mounted on the sensor board 30 in the present embodiment. The three sensors 35 are circumferentially arranged at equal intervals of 60 degrees around the motor axis J. The sensor board 30 is arranged in the first direction with respect to the rotor 28. The sensor board 30 is integrally attached to and supported by the insulator 26. The sensor board 30 and the three sensors 35 forms a sensor unit. The sensor unit includes a mold 34, diodes 36, signal lines 37, conductor patterns 39, etc.

As shown in FIGS. 3 to 6, the sensor board 30 is made by processing a plate-shaped substrate material. For example, glass fibers impregnated with an epoxy resin are heated and cured to obtain the substrate material. The sensor board 30 includes an annular board main body 31 in which a circular through-hole is formed in the center of the board main body 31. An inner circumferential edge 31b of the board main body 31 corresponds to a side surface of the circular through-hole. The motor shaft 27 is inserted on an inner peripheral side of the inner circumferential edge 31b of the board main body 31.

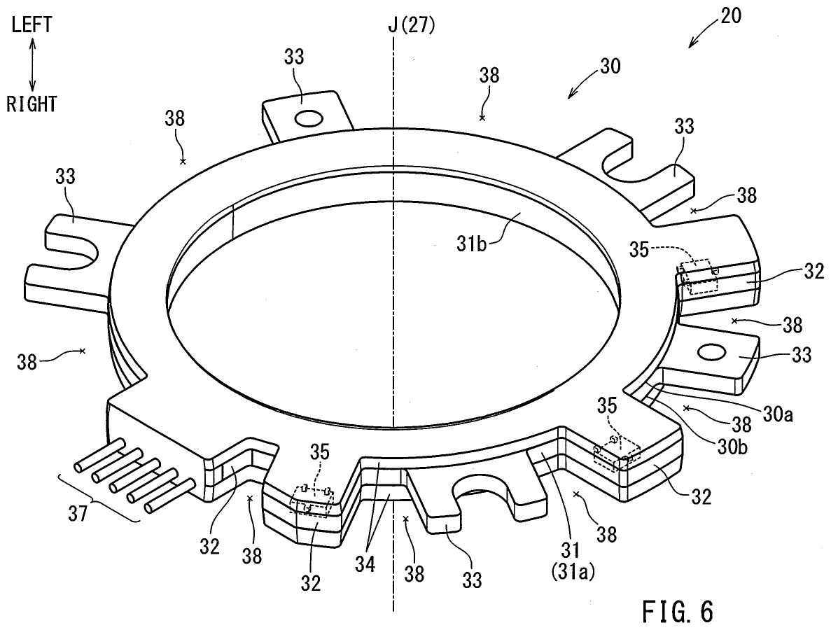

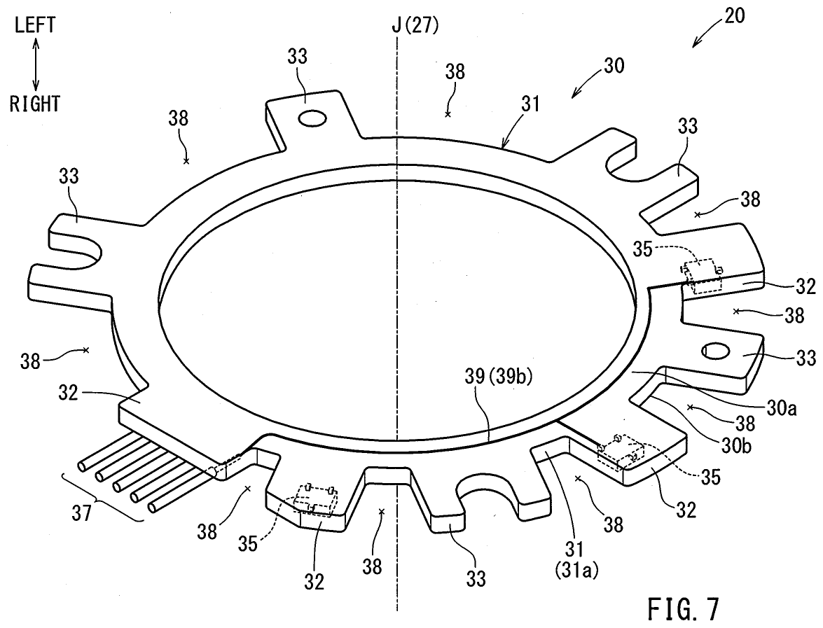

As shown in FIGS. 3 to 8, the sensor board 30 includes a plurality of legs 32 protruding radially outward from an outer circumferential edge 31a of the board main body 31. In the present embodiment, four legs 32 are provided. As shown in FIGS. 6 and 7, a sensor 35 is attached to each of three legs 32 out of the four legs 32. Each sensor 35 is attached to an inner side surface 30b of the leg 32 on the second direction side so as to be able to face the magnets 28c. Signal lines 37 extend radially outward from one of the four legs 32. The signal lines 37 are electrically connected to the connection portions 26b of the insulator 26. The sensors 35 are electrically connected to the controller 14 via the signal lines 37.

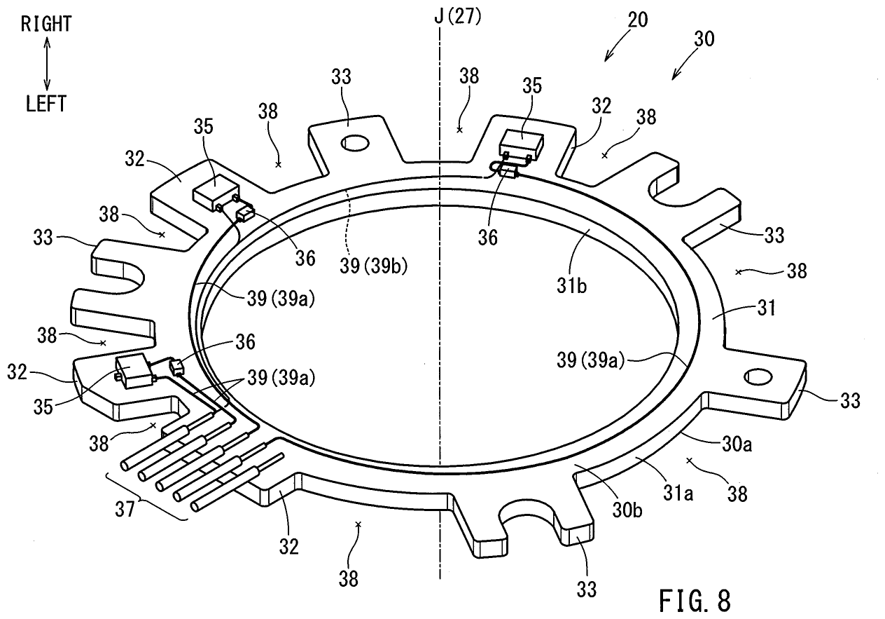

As shown in FIGS. 5 and 8, the sensor unit includes a plurality of diodes 36. Each of the diodes 36 is arranged adjacent to a corresponding sensor 35 on the sensor board 30 and electrically connected to the corresponding sensor 35. In the present embodiment, three diodes 36 are arranged on the sensor board 30. The diodes 36 are arranged on the inner side surface 30b in the second direction.

As shown in FIGS. 5, 7 and 8, conductor patterns 39 are formed on both surfaces of the sensor board 30. Each of the sensors 35 is electrically connected to a corresponding diode 36 and signal line 37 via the conductor patterns 39. Inner side conductor patterns 39a formed on the inner side surface 30b of the sensor board 30 include arc-shaped portions extending in a circumferential direction of the board main body 31. The inner side conductor patterns 39 further extend from the arc-shaped portions to the sensors 35 and the signal lines 27 disposed on the legs 32. Outer side conductor patterns 39b are formed on an outer side surface 30a on the first direction side of the sensor board 30. Similar to the inner side conductor patterns 39a, the outer side conductor patterns 39b include an arc-shaped portion extending in a circumferential direction of the board main body 31 and portions extending from the arc-shaped portions to the sensors 35 and the signal lines 37 disposed on the legs 32.

As shown in FIGS. 3 to 8, the sensor board 30 includes a plurality of mounting legs 33 protruding radially outward from the outer circumferential edge 31a of the board main body 31. In the first embodiment, five mounting legs 33 are provided. Each of the mounting legs 33 is attached to a corresponding board connection portion 26c of the insulator 26 by, for example, a screw etc. Spaces in a circumferential direction of the sensor board 30 are formed between the mounting legs 33 and also between the mounting leg 33 and a corresponding leg 32 adjacent to the mounting leg 33. Slits 38, through which outside air flows from outside of the sensor board 30 toward inside of the motor 20, are formed in the spaces in the circumferential direction of the sensor board 30.

As shown in FIGS. 4 and 6, the sensor unit includes two resin molds 34. One of the two resin molds 34 covers the outer side surface 30a in the first direction. The other of the two resin molds 34 covers the inner side surface 30b in the second direction. The molds 34 are formed on the board main body 31 and the legs 32. The molds 34 are not formed in the mounting legs 33. The mounting legs 33 are screw-connected to corresponding board connection portions 26c in an easily manner by not forming the molds in the mounting legs 33. The molds 34 do not cover the outer circumferential edge 31a of the board main body 31 and circumferential edge surfaces of the legs 32. Because of this configuration, it can be prevented that the opening area of the slits 38 is reduced owing to the molds 34. In FIGS. 5, 7 and 8, the molds 34 are omitted for the purpose of explanation.

As shown in FIGS. 2, 4 and 5, the slits 38 are between the inner circumferential edge 22c of the stator 22 and the outer circumferential edge 31a of the board main body 31 in a radial direction of the sensor board 30. Also, the slits 38 are between the mounting legs 33 and between the mounting leg 33 and the leg 32 adjacent to the corresponding mounting leg 33 in a circumferential direction of the sensor board 30. When viewed in the first direction, the inner circumferential edge 22c of the stator 22 are exposed on both sides of the legs 32 in the circumferential direction of the board main body 31. Also, when viewed in the first direction, the inner circumferential edge 22c of the stator 22 are exposed on both sides of the mounting legs 33 in the circumferential direction of the board main body 31. The outer circumferential edge 31a of the board main body 31 is located radially inward of a center of the inner circumferential end 24a of each teeth 24. When viewed in the first direction, the center of the inner circumferential end 24a of each teeth 24 is exposed from the slits 38. In other words, when viewed in the first direction, all of the legs 32 and the mounting legs 33 are positioned so as to avoid the center of the inner circumferential end 24a of each teeth 24.

A cooling air generated by rotation of the cooling fan 15 flows inside of the stator 33 through the slits 38. An air resistance of the motor 20 can be reduced when the cooling air flows through the slits 38. Because of this configuration, the cooling air is sufficiently blown against the coil 25 wound around each teeth 24 to cool the coil 25. The cooling air flowing through the slits 38 cools not only the coil 25 but also, for example, the sensors 35 on the sensor board 30 etc. The cooling air that has cooled the motor 20 flows to the cooling fan 15 and is discharged from the exhaust port 11b.

As described above, the motor 20 used for an electric power tool 1 includes a cylindrical-shaped stator 22 as shown in FIGS. 3 to 5. The motor 20 includes the rotor 28 arranged on the inner circumferential side of the stator 22. The motor 20 includes the sensor board 30 arranged at the axial end of the stator 22. The sensor board 30 includes the board main body 31 arranged radially inward of the stator 22 when viewed from the axial direction of the stator 22. The sensor board 30 includes legs 32 protruding radially outward from the board main body 31 toward the stator 22. The stator 22 is exposed on at least one side of each leg 32 in the circumferential direction of the stator 22. The motor 35 includes sensors 35 each of which is mounted on one of the legs 32 and detects rotation of the rotor 28 when facing the magnets 28c of the rotor 28.

A cooling air flows inside the stator 22 from a portion in which the stator 22 is exposed on at least the one side of each leg 32 in the circumferential direction of the stator 22. Accordingly, an air resistance of the motor 20 can be reduced. Each of the sensors 35 is mountable on one of the legs 32 protruding radially outward from the board main body 31 of the sensor board 30. The stator 22 is exposable in at least one side of the each leg 32 in the circumferential direction of the stator 22. Because of this configuration, the stator 22 is exposed in a broad area along the inner circumferential edge 22c of the stator 22 while the sensors 35 are arranged in positions to sense and detect rotation of the rotor 28. Accordingly, a cooling air flows along the inner circumferential edge 22c of the stator 22, thereby increasing a quantity of cooling air flowing through the inside of the motor 20. Thus, even when an output power of the motor 20 is increased and/or surged, the motor 20 and the like can be restricted from being damaged.

As shown in FIGS. 2 to 5, the stator 22 includes a cylindrical-shaped outer cylinder portion 23. The stator 22 includes teeth 24, each of which protrudes radially inward from the outer cylinder portion 23 and a coil 25 is wound around. An inner circumferential end 24a of each of the teeth 24 is exposable when viewed from an axial direction of the stator 22. Because of this configuration, an exposed area of each teeth 24 viewed from the axial direction of the stator 22 can be increased. Accordingly, the coil 25 wound around each teeth 24 can be efficiently cooled by a large quantity of cooling air.

As shown in FIGS. 3 and 4, the sensor board 30 includes mounting legs 33 attachable to the stator 22. The mounting legs 33 protrude radially outward from the board main body 31. A cooling air flows into an area adjacent to the mounting legs 33 in a circumferential direction of the stator 22 by arranging the mounting legs 33 protruding radially outward from the board main body 31. Accordingly, a flowing quantity of cooling air can be increased while stability of a supporting configuration for supporting the sensor board 30 is improved.

As shown in FIGS. 2 to 5, the stator 22 includes a cylindrical-shaped outer cylinder portion 23. The stator 22 includes a plurality of teeth 24, each of which protrudes radially inward from the outer cylinder portion 23 and a coil 25 is wound around. The legs 32 and the mounting legs 33 are positioned differently from the center of the inner circumferential end 24a of each of the plurality of teeth 24 when viewed from the axial direction of the stator 22. In other words, the legs 32 and the mounting legs 33 are arranged in areas though which a cooling air flowing toward the teeth 24 in the axial direction of the board main body 31 does not pass. Accordingly, a coil 25 wound around each of the teeth 24 can be efficiently cooled by the cooling air, thereby improving a cooling efficiently of the motor 20.

As shown in FIGS. 4 and 5, the sensor board 30 includes at least one leg 32. Also, the sensor board 30 includes at least one mounting leg 33. Each of the legs 32 and each of the mounting legs 33 are positioned so as to avoid the center of the inner circumferential end 24a of each teeth 24 when viewed from in the axial direction of the stator 22, and thus the center of the inner circumferential end 24a of each of the plurality of teeth 24 is exposed. Accordingly, the center of the inner circumferential end 24a of each teeth 24 is exposed when viewed from in the axial direction of the stator 22. Because of this configuration, a cooling efficiently of the motor 20 can be further improved, while the sensors 35 on the legs 32 can be arranged in positions so as to sufficiently detect rotation of the rotor 28 and also stability of a supporting configuration for supporting the sensor board 30 by the mounting legs 33 can be improved.

As shown in FIGS. 2 to 5, the motor 20 includes an outer cylinder portion 23 of the cylinder-shaped stator 22. The motor 20 includes a plurality of teeth 24 each of which protrudes radially inward from the outer cylinder portion 23 and a coil 25 is would around. The motor 20 includes a rotor 28 arranged on an inner circumferential side of the plurality of teeth 24. The motor 20 includes a sensor board 30 arranged at an axial end of the stator 22. The sensor board 30 includes an annular board main body 31 along a radially inward of the inner circumferential end 24a of the plurality of teeth 24 when viewed from an axial direction of the stator 22. A center of at least one inner circumferential end 24a of the plurality of teeth 24 is exposed in a direction radially outward of the board main body 31. The motor 20 includes a sensor 35 which is mounted on the sensor board 30 so as to face the rotor 28 and detects rotation of the rotor 28 when faces the magnet 28c of the rotor 28.

A space is formed between the board main body 31 and the inner circumferential ends 24a of the teeth 24 in a radial direction of the stator 22. The formation of the space increases the exposable area of the teeth 24, and reduces an air resistance of the motor 20. A center of at least one inner circumferential end 24a of the plurality of teeth 24 is exposable when viewed from an axial direction of the stator 22. A cooling air flows adjacent to the center of the inner circumferential end 24a of each of the teeth 24 and cools down a coil 25 that wound around each of the teeth 24. Even a surge and/or increase of output power of the motor 20 does not damage the motor 20 and the like.

As shown in FIGS. 4 to 8, the sensor board 30 includes legs 32 protruding radially outward from the board main body 31. A sensor 35 is mounted on each of the leg 32. Accordingly, a space is provided adjacent to each leg 32 in a circumferential direction of the sensor board 30, while the sensors 35 are arranged on the legs 32 so as to sufficiently detect rotation of the rotor 28. Because of this configuration, a flowing quantity of the cooling air flowing into an inside of the motor 20 can be increased.

As shown in FIGS. 4 and 5, the sensor board 30 includes at least one mounting leg 33 which protrudes radially outward from the board main body 31 and is attached to the stator 22. The sensor board 30 includes at least one leg 32 which protrudes radially outward from the board main body 31 and on which the sensor 35 is mounted. All of the legs 32 and the mounting legs 33 are arranged so as to avoid the center of the inner circumferential end 24a of each teeth 24 when viewed in the axial direction of the stator 22. Because of this configuration, all of the centers of the inner circumferential ends 24a of the plurality of teeth 24 are exposed. Accordingly, all coils 25 each of which is would around a corresponding one of the teeth 24 can be efficiently cooled, thereby further improving a cooling efficiency of the motor 20.

As shown in FIGS. 4 to 8, the motor 20 includes three sensors 35. The sensor board 30 includes three legs 32 on each of which one of the sensor 35 is mounted. Thus, rotation of the rotor 28 can be sufficiently detected by use of the three sensors 35. Also, by arranging each of three sensors 35 on a corresponding leg 32, a space adjacent to each leg 32 in the circumferential direction of the stator 22 can be enlarged. Accordingly, a quantity of the cooling air flowing into the inside of the motor 20 can be increased.

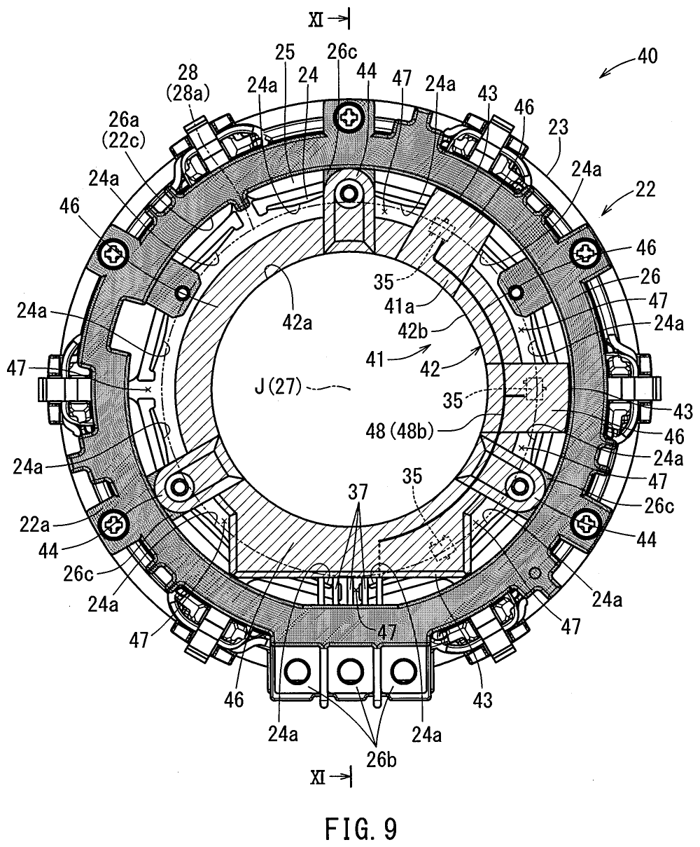

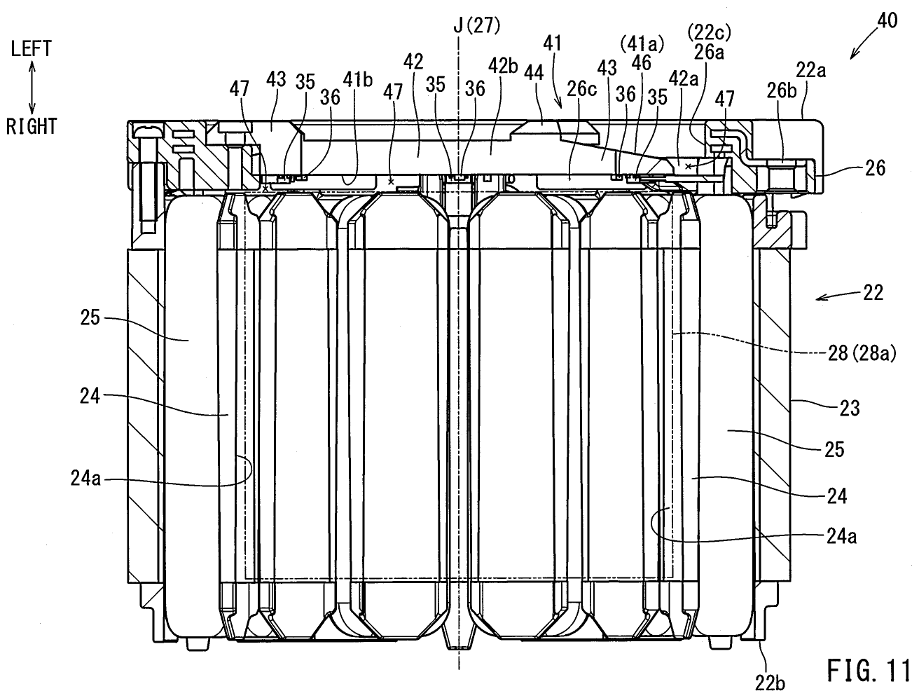

Next, a second embodiment of the present disclosure will be explained with reference to FIGS. 9 to 13. A motor 40 used for an electric power tool 1 in the second embodiment includes a sensor board 41 instead of the sensor board 30 shown in, for example, FIG. 6. In the following explanation, descriptions that differ from the first embodiment will be explained in detail. Since the structures and functions of several components in the second embodiment are identical to those in the first embodiment, the corresponding components are designated by the same reference numbers as in the first embodiment.

As shown in FIGS. 9 to 13, the motor 40 includes three sensors 35 mounted on the sensor board 41. The sensor board 41 and the three sensors 35 forms a sensor unit. The sensor unit includes a mold, diodes 36, signal lines, conductor patterns 48, etc. The conductor patterns 48 will be discussed later in detail. The sensor board 41 is arranged on a first direction side with respect to the rotor 28. The sensor board 41 is integrally attached to and supported by the insulator 26. The sensor board 41 is a solid molding component made of a synthetic resin, which is referred to as a MID (molded Interconnect device). The sensor board 41 includes an annular board main body 42 in which a circular through-hole is formed in the center of the board main body 42. An inner circumferential edge 42b of the board main body 42 corresponds to a side surface of the circular through-hole. The motor shaft 27 is inserted on an inner peripheral side of the inner circumferential edge 42b of the board main body 42.

As shown in FIGS. 9 to 13, the sensor board 41 includes a plurality of legs 43 protruding radially outward from an outer circumferential edge 42a of the board main body 42. In the second embodiment, three legs 43 are provided. As shown in FIG. 9, a sensor 35 is attached to each of three legs 43. Each sensor 35 is mounted on an inner side surface 41b of the leg 43 on the second direction side so as to be able to face one of the magnets 28c (refer to FIG. 2). One of the legs 43 has a rectangular shape which is long in the circumferential direction of the board main body 42. As shown in FIG. 9, signal lines 37 extend toward a radially outward direction from the rectangular-shaped leg 43. The sensor unit includes three diodes 36. Each diode 36 is mounted on the inner side surface 41b of the board main body 42.

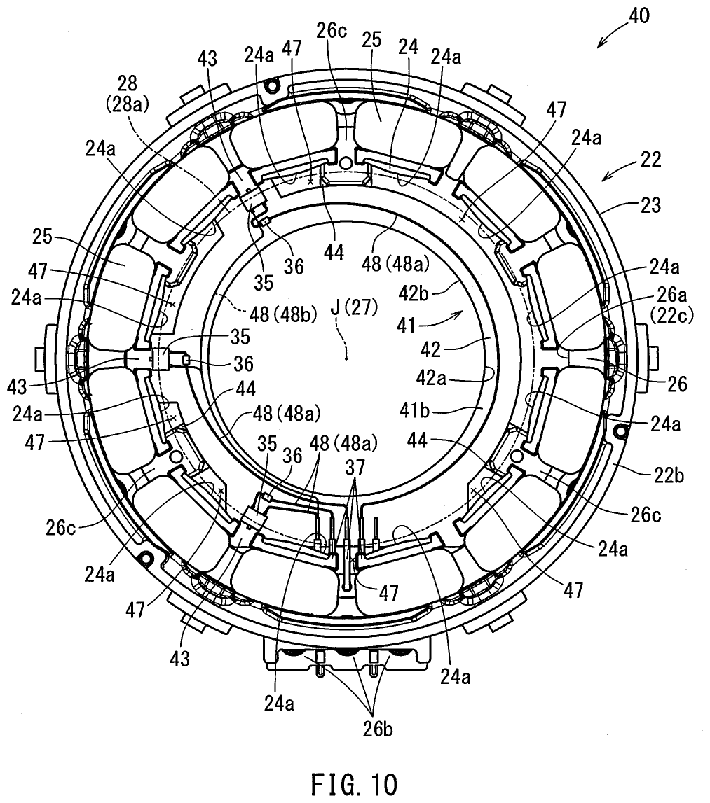

As shown in FIGS. 10, 12 and 13, conductor patterns 48 are formed on both surfaces of the sensor board 41. Each of the sensors 35 is electrically connected to a corresponding diode 36 and signal line 37 via the conductor patterns 48. Inner side conductor patterns 48a formed in the inner side surface 41b of the sensor board 41 include arc-shaped portions extending in a circumferential direction of the board main body 42. The inner side conductor patterns 48a further extend from the arc-shaped portions to the sensors 35 and the signal lines 37 disposed on the legs 43. Outer side conductor patterns 48b are formed on an outer side surface 41a on the first direction side of the sensor board 41. Similar to the inner side conductor patterns 48a, the outer side conductor patterns 48b include an arc-shaped portion extending in a circumferential direction of the board main body 42 and portions extending from the arc-shaped portions to the sensors 35 and the signal lines 37 disposed on the legs 37.

As shown in FIGS. 9 to 13, the sensor board 41 includes the mounting legs 44 which protrude radially outward from an outer circumferential edge 42a of the board main body 42. In the second embodiment, about three mounting legs 44 are provided. Each of the mounting legs 44 is attached to a corresponding board connection portion 26c of the insulator 26 by, for example, a screw etc. Each mounting leg 44 is arranged on the first direction side rather than the inner side surface 41b of the sensor board 41 on which the sensors 35 is mounted. Because of this configuration, screwing positions can be arranged further away from the rotor 28 than the sensors 35 in comparison with the first embodiment. In this manner, since the sensor board 41 is an MID, the arrangement of the sensors 35 and the screwing position and a thickness of the board main body 42, etc. can be designed with high flexibility. Spaces are formed in the circumferential direction of the sensor board 41 between the mounting legs 44 and between the mounting leg 44 and the leg 43 adjacent to a corresponding mounting leg 44. Accordingly, slits 47 are formed in these spaces so as to be able to introduce a cooling air from outside of the sensor board 41 into the inside of the motor 40.

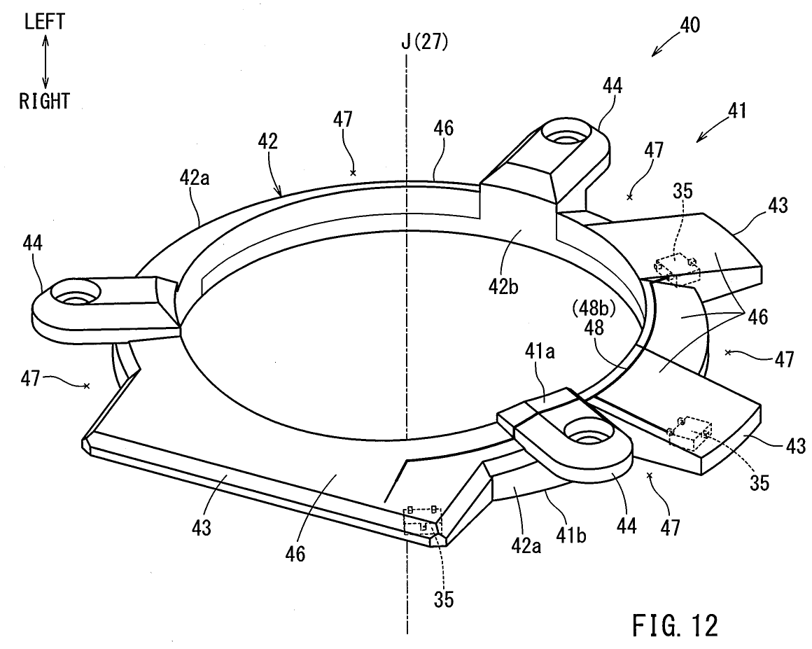

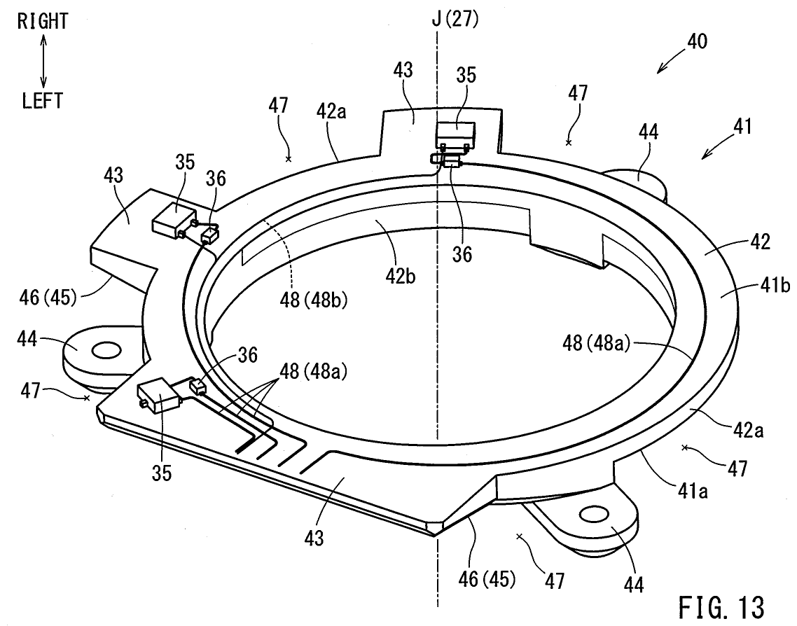

As shown in FIGS. 12 and 13, a tilting surface 43 is formed on the outer side surface 41a on the first direction side of the sensor board 41 so as to be tilted in the radial direction of the sensor board 41. The tilting surface 43 is formed on the board main body 42 and the legs 43. The tilting surface 46 is formed to avoid the mounting legs 44, which do not include the tilting surface 46. The tilting surface 46 is tilted to the second direction on an axially inner side of the motor 40 toward a radially outward slit 47. In the board main body 43, the tilting surface 46 is formed at approximately the same tilting angle over an entire surface of the board main body 42 from the inner circumferential edge 42b to the outer circumferential edge 42a. In the legs 43, the tilting surface 46 is formed at approximately the same tilting surface over the entire surface of the legs 43 from the inner circumferential edge 42b to an outer circumferential edge of the legs 43. In the figures, molds made of synthetic resin that cover the outer side surface 41a and the inner side surface 41b are omitted. The molds are provided on the board main body 42 and the legs 43. The molds are not provided on the mounting legs 44. Outer side surfaces of the molds are formed approximately parallel to the tilting surface 46, i.e., to be tilted toward the slit 47 radially outward.

As shown in FIGS. 9 and 10, the slits 47 are formed between the inner circumferential edge 22c of the stator 22 and the outer circumferential edge 42a of the board main body 42 in the radial direction of the motor 40. The slits 47 are formed between the mounting legs 44 and between the mounting leg 44 and the leg 43 adjacent to the mounting leg 44 in the circumferential direction of the board main body 42. When viewed from the first direction side, the inner circumferential edges 22c of the stator 22 are exposed on both sides of the legs 43 in its circumferential direction. The outer circumferential edge 42a of the board main body 42 is arranged radially inward of the center of the inner circumferential end 24a of the teeth 24. When viewed from the first direction side, the inner circumferential ends 24a of all teeth 24 are exposed from the slits 47. In the second embodiment, regarding ten teeth 24 out of the twelve teeth 24, excluding two teeth 24 that overlap the rectangular-shaped leg 43 which is long in the circumferential direction of the board main body 42, the centers of the inner circumferential ends 24a of the teeth 24 are exposed from the slit 47 when viewed from the first direction side.

As discussed above, the motor 40 used for the electric power tool 1 includes the cylindrical-shaped stator 22 as shown in FIGS. 9 to 11. The motor 40 includes the rotor 28 arranged on the inner circumferential side of the stator 22. The motor 40 includes the sensor board 41 at the axial end of the stator 22. The sensor board 41 includes the board main body 42 located radially inward of the inner circumferential edge 22c of the stator 22 when viewed from the axial direction of the stator 22. The sensor board 41 includes the outer side surface 42 of the board main body 42 disposed on a side opposite to the rotor 28. The sensor board 41 includes a tilting surface 46 on the outer side surface 41a of the board main body 42 so as to be tilted toward the inner side in the axial direction of the stator 22 (the second direction side), where the rotor is located, as it extends radially outward. When viewed from the axial direction, a space (slit 47) is formed between the outer circumferential edge 42a of the board main body 42 and the inner circumferential edge 22c of the stator 22. The motor 40 includes sensors 35 that are mountable on the sensor board 41 so as to face the rotor 28 and detect rotation of the rotor 28 when facing the magnets 28c of the rotor 28.

The tilting surface 46 is formed on the outer side surface 41a of the board main body 42 so as to be tilted toward the inner side in the axial direction of the motor 40. Because of this configuration, a cooling air flowing toward the board main body 42 can be guided by the tilting surface 46. Accordingly, an air resistance of the motor 40 can be reduced. The tilting surface 46 is tilted toward the inner side in the axial direction of the motor 40, where the rotor is located, as it extends radially outward. Accordingly, a cooling air can be guided toward the inner circumferential edge 22c of the stator 22 which is located radially outward of the tilting surface 46. Because of this configuration, a flowing quantity of the cooling air can be increased, thereby improving a cooling efficiency of the motor 40. Accordingly, even in a case where an output power of the motor 40 is increased, the motor 40 and the like can be restricted from being damaged.

As discussed above, the motor 40 includes molds covering the surfaces of the board main body 42. The tilting surface 46 is formed according to the configurations of the outer side surface 41a of the board main body 42 or configurations of the molds. Accordingly, with regard to the board main body 42 that is covered by the molds, the tilting surface 46 for guiding the cooling air can be formed, thereby reducing the air resistance of the motor 40.

As shown in FIGS. 12 and 13, the sensor board 41 includes the mounting legs 44 each of which protrudes radially outward from the board main body 42 and is attached to the stator 22. The mounting legs 44 do not include the tilting surface 46. Accordingly, strength of the mounting legs 44 can be maintained, while the tilting surface 46 is formed on a required position for guiding the cooling air so as to increase a cooling efficiency of the motor 40.

As shown in FIGS. 9 to 13, the sensor board 41 includes the legs 43 protruding radially outward from the board main body 42. The sensors 35 are mounted on the legs 43. The sensors 35 for detecting rotation of the rotor 28 are mounted on the legs 43, which does not avoid the cooling air to be guided to the inside of the motor 40 along the tilting surfaces 46 of the board main body 42. Because of this configuration, air resistance can be reduced, thereby improving a cooling efficiency of the motor 40.

As shown in FIGS. 9 and 12, the tilting surface 46 is tilted over the entire surface from the inner circumferential edge 42b to the outer circumferential edge 42a of the board main body 42 in the radial direction of the board main body 42. Accordingly, the cooling air flowing toward the board main body 42 in the axial direction of the stator 22 can be smoothly guided outward in the radial direction of the board main body 42. Because of this configuration, an air resistance owing to the board main body 42 can be reduced, thereby improving a cooling efficiency of the motor 40.

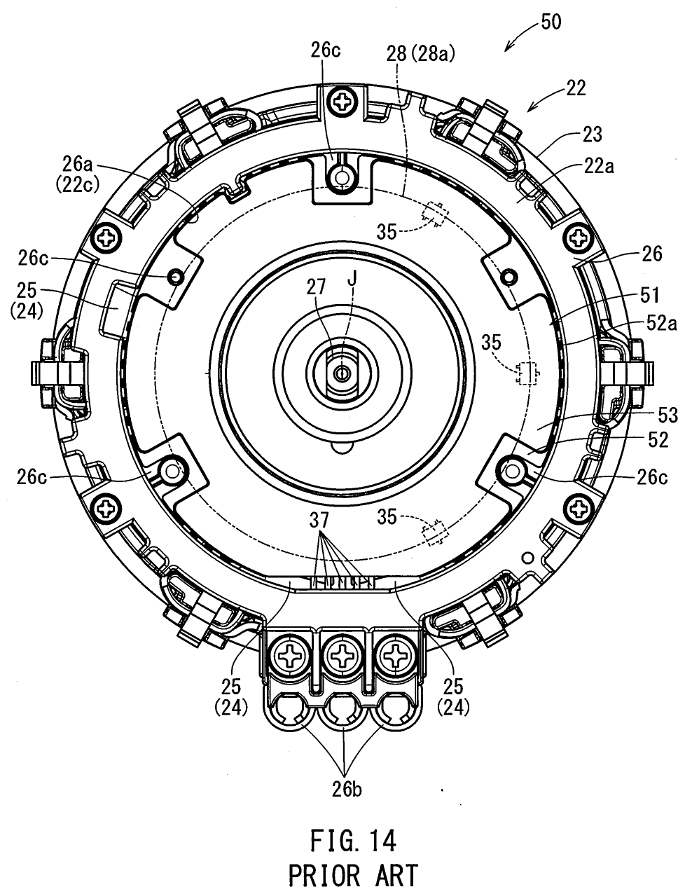

FIG. 14 shows a motor 50 used for an electric power tool 1 in the prior art for comparison with the present embodiments. A sensor board 51 arranged in the motor 50 in the prior art includes a disk-shaped board main body 52. Sensors 35 are mountable on an inner side surface of the board main body 52. An outer side surface and an inner side surface of the board main body 52 are covered by molds 53. The board main body 52 is connected to board connection portions 26c of the insulator 26 in the vicinity of the outer circumferential edge 52a of the board main body 52. Accordingly, only a slight space is formed between the outer circumferential edge 52a of the board main body 52 and the inner circumferential edge 22c of the stator 22. When viewed in the axial direction of the motor 50, most of teeth 24 are not exposable, and only a part of the teeth 24 can be seen in an area where signal lines 37 are arranged. In this manner, in comparison with the first embodiment and the second embodiment, there is a slight space through which the cooling air flows inside the stator 22, and accordingly an air resistance becomes large.

The motor 20, 40 used for the electric power tool according to the above-discussed embodiments may be modified in various ways. In the above-exemplified embodiment, the motor 20, 40 is used in a chain saw. Instead, the present disclosure may be applied to an electric power tool such as, for example, a fastener, an electric drill, a miter saw, a grinder, a cleaner, a blower etc. Also, a number of teeth 24 and a number of magnets 28c arranged in the rotor 28 may be modified without limiting the exemplified numbers.

In the above-discussed embodiments, three sensors 35 are used for detecting rotation of the rotor 28. Instead, for example, one sensor 25 may be used. In the above-discussed embodiments, one sensor 35 is mounted on each leg 32, 43. Instead, for example, a plurality of sensors 35 may be mounted on each leg 32, 43. The configurations of the present embodiments may be preferable in that total opening area of slits 38, 47 can be enlarged.

In the above-discussed embodiments, the annular board main body 31, 42 are exemplified. Instead, for example, a C-shaped board extending in the circumferential direction of the motor shaft 27 may be used. In the above-discussed embodiments, the board main body 31, 42 whose outer circumferential edge 31a, 42a are circular. Instead, for example, the outer circumferential edge 31am 42a may be polygonal. In the above-discussed embodiments, the diodes 36 are mounted on the board main body 31, 42. Instead, for example, the diodes 36 may be mounted on the leg 32, 43.

In the above-discussed embodiments, the slits 38, 47 are positioned on both sides of the legs 32, 43 in the circumferential direction. Instead, for example, the slits 38, 47 may be positioned on one side of the legs 32, 43 in the circumferential direction. In the above-discussed embodiments, the legs 32, 43 are separate components from the mounting legs 33, 44. Instead, for example, the leg and the mounting leg may be used in common. The mounting legs 33, 34 are preferably three or more than three, more preferably five or three, more preferably four or six, or more preferably more than four or six.

In the above-discussed embodiments, when viewed from the axial direction of the motor 20, 40, the center of the inner circumferential edge 24 of each teeth 24 is exposable from the slits 38. Instead, the center of the inner circumferential edge 24 of a part of teeth 24 may be exposed from the slits 38. The more the exposed area is, the more sufficiently an air resistance is reduced.

In the above-discussed embodiments, the tilting surface 46 is formed on the outer side surface 41a of both the board main body 42 and the legs 43. Instead, for example, the tilting surface 46 may be formed on the outer side surface 41a of either the board main body 42 or the legs 43. Instead, the tilting surface 46 may be formed on the outer side surface 41a of a part of the plurality of legs 43 and on the outer side surface 41a of the board main body 42.

In the above-discussed embodiments, the sensor board 41 is an MID and the molds are formed on the outer side surface 41a of the board main body 42 and the legs 43 extending approximately parallel to the tilting surface 46. Instead, for example, the sensor board 41 may be formed by a plate-shaped material similar to the sensor board 30 and a tilting surface may be formed on an outer side surface of the molds. This configuration may be made, for example, by forming a tilting surface on the outer side surface of the molds 34.

The configurations of the conductor patterns on the sensor board 30, 41 may be modified without limiting the exemplified conductor patterns 39, 48. For example, the conductor patterns may be formed only the outer side surface 30a, 41a or only the inner side surface 30b, 41b of the sensor board 30, 41. In the above-discussed embodiments, the number of the inner side patterns 39a, 48a is more than that of the outer side patterns 39b, 48b. Instead, the number of the outer side patterns 39b, 48b may be more than that of the inner side patterns 39a, 48a. Capacitors etc. electrically connected to each sensor 35 may be mounted on the sensor board 30, 41.

We claim:

1. A motor used for an electric power tool, comprising:
a stator that is cylindrical-shaped;
a rotor arranged on an inner circumferential side of the stator; and
a sensor board arranged at an axial end of the stator, wherein:
the sensor board further comprises:
a board main body located radially inside of the stator when viewed from an axial direction of the stator;
a leg configured to protrudes radially outward from the board main body; and
a sensor that is mountable on the leg so as to face the rotor and detects rotation of the rotor, and
the stator is configured to be exposable on at least one side of the leg in a circumferential direction of the stator.

2. The motor according to claim 1, wherein:
the stator includes (a) a cylindrical-shaped outer cylinder portion and (b) a plurality of teeth, each of which protrudes radially inward from the outer cylinder portion and a coil is wound around, and
an inner circumferential end of each of the plurality of teeth is exposable when viewed from the axial direction of the stator.

3. The motor according to claim 1, wherein the sensor board further comprises a mounting leg that is configured to protrude radially outward from the board main body and that is attachable to the stator.

4. The motor according to claim 3, wherein:
the stator includes (a) a cylindrical-shaped outer cylinder portion and (ii) a plurality of teeth, each of which protrudes radially inward from the outer cylinder portion and a coil is wound around, and
the leg and the mounting leg are positioned differently than a center of the inner circumferential end of each of the plurality of teeth when viewed from the axial direction of the stator.

5. The motor according to claim 4, wherein:
the sensor board further comprises at least one leg and at least one mounting leg, and
each of the at least one leg and each of the at least one mounting leg are positioned differently than the center of the inner circumferential end of each of the plurality of teeth, such that the center of the inner circumferential end of each of the plurality of teeth is exposable when viewed from the axial direction of the stator.

6. The motor according to claim 1, wherein:
the motor includes three sensors, and
the sensor board includes three legs on each of which one of the three sensors is mountable.

7. A motor used for an electric power tool, comprising:
a stator that is cylindrical-shape and includes an outer cylinder portion;
a plurality of teeth each of which protrudes radially inward from the outer cylinder portion and a coil is wound around;
a rotor arranged on an inner circumferential side of the plurality of teeth,
a sensor board arranged at an axial end of the stator, wherein:
the sensor board further comprises:
a board main body that is annular and disposed along a radially inward of an inner circumferential end of each of the plurality of teeth when viewed from an axial direction of the stator; and
a sensor that is mountable on the sensor board so as to face the rotor and detects rotation of the rotor, and
a center of at least one inner circumferential end of each of the plurality of teeth is exposable in a direction radially outward of the board main body.

8. The motor according to claim 7, wherein the sensor board further comprises a mounting leg that is configured to protrude radially outward from the board main body and that is attachable to the stator.

9. The motor according to claim 7, wherein:
the sensor board further comprises a leg radially outward from the board main body, and
the sensor is mountable on the leg.

10. The motor according to claim 7, wherein:
the sensor board includes (a) at least one mounting leg that is configured to protrude radially outward from the board main body and that is attachable to the stator and (b) at least one leg which is configured to protrude outward from the board main body and on which a sensor is mountable, and
each of the at least one leg and each of the at least one mounting leg are positioned differently than a center of an inner circumferential end of each of the plurality of teeth, such that the center of the inner circumferential end of each of the plurality of teeth is configured to be exposable when viewed from the axial direction of the stator.

11. The motor according to claim 9, wherein:
the motor includes three sensors, and
the sensor board includes three legs on each of which one of the three sensors is mountable.

12. A motor used for an electric power tool, comprising:
a stator that is cylindrical-shaped;
a rotor arranged on an inner circumferential side of the stator; and
a sensor board arranged at an axial end of the stator, wherein:
the sensor board further comprises:
a board main body located radially inward of an inner circumferential edge of the stator when viewed from an axial direction of the stator;
an outer side surface of the board main body disposed on a side opposite to the rotor;
a tilting surface on the outer side surface of the board main body so as to be tilted toward an inner side in an axial direction of the stator as it extends radially outward; and
a sensor that is mountable on the sensor board so as to face the rotor and detects rotation of the rotor, and
a space is formed between an outer circumferential edge of the board main body and the inner circumferential edge of the stator when viewed from the axial direction of the stator.

13. The motor according to claim 12, further comprising a mold that is configured to cover a surface of the board main body, wherein,
the tilting surface is formed according to a configuration of the outer side surface of the board main body or a configuration of the mold.

14. The motor according to claim 12, wherein:
the sensor board further comprises a mounting leg that is configured to protrude radially outward from the board main body and that is attachable to the stator, and
the tilting surface is formed on the sensor board except the mounting leg.

15. The motor according to claim 12, wherein:
the sensor board further comprises a leg configured to protrudes radially outward from the board main body, and
the sensor is mountable on the leg.

16. The motor according to claim 12, wherein the tilting surface is tilted over an entire surface from an inner circumferential edge of the board main body to the outer circumferential edge of the board main body in a radial direction of the board main body.

17. The motor according to claim 15, wherein:
the motor includes three sensors, and
the sensor board includes three legs on each of which one of the three sensors is mountable.

18. The motor according to claim 17, wherein each of the three sensors is mountable on a surface opposite to the outer side surface of the board main body.

19. The motor according to claim 16, wherein the tilting surface is formed at approximately a same tilting angle over the entire surface of the board main body.

20. The motor according to claim 15, wherein the leg is formed to be tilted on a same surface side as the outer side surface of the board main body.
